(19) United States
(12) Patent Application Publication
(10) Pub. No.: US 2026/0201208 A1
(43) Pub. Date: Jul. 16, 2026

(54) THICKENER-FREE AQUEOUS COATING COMPOSITION

(71) Applicant: AXALTA COATING SYSTEMS IP CO., LLC, Wilmington, DE (US)

(72) Inventors: Shih-Wa Wang, Glen Mills, PA (US); Michael S. Wolfe, Wilmington, DE (US); Austin Boyd, Media, PA (US)

(73) Assignee: AXALTA COATING SYSTEMS IP CO., LLC, Wilmington, DE (US)

(21) Appl. No.: 19/445,878

(22) Filed: Jan. 12, 2026

Related U.S. Application Data
(60) Provisional application No. 63/744,573, filed on Jan. 13, 2025.

(51) Int. Cl. C09D 175/08; C09D 5/02

(52) U.S. Cl. CPC C09D 175/08; C09D 5/022

(57) ABSTRACT

An aqueous coating composition includes water; a crosslinker; and a resin dispersion comprising a latex, a polyurethane, or combinations thereof. Specifically, the composition is free of a thickener and exhibits a viscosity of less than or equal to about 100 cP, measured at a shear rate of from about 0.1 s⁻¹ to about 10 s⁻¹. Furthermore, the composition is sag-free, determined by a 90-degree tilt test, when applied to and in direct contact with a partially dried coating substrate having a solids content of greater than about 80 wt %, based on a total weight of the coating substrate.

### CROSS-REFERENCE TO RELATED APPLICATIONS

This application claims the benefit of U.S. Provisional Application No. 63/744,573 filed on Jan. 13, 2025, which is hereby expressly incorporated herein by reference in its entirety.

### TECHNICAL FIELD

The present disclosure generally relates to an aqueous coating composition including water, a crosslinker, and a resin dispersion comprising a latex, a polyurethane, or combinations thereof. More specifically, the composition is free of a thickener and achieves specific viscosity and sag free metrics.

### BACKGROUND

Ink jet printing is a non-impact printing process in which droplets of ink are deposited on a structure, typically made of paper or textile fabrics, in response to an electronic signal. A specific application of this process, digital printing, allows for precise tailoring to individual process requirements. The droplets can be jetted onto the structure by a variety of inkjet application methods including continuous and drop-on-demand printing. In drop-on-demand printing, the energy to eject a droplet of ink can originate from a thermal resistor, a piezoelectric crystal, acoustic or a solenoid valve. These methods generally use high transfer efficiency applicators.

In the automotive industry, a vehicle body is typically coated with a series of finishes each having a particular function, including an electrocoat, a primer, a colored basecoat providing a color and a clear topcoat to provide addition protection and a glossy finish. Currently, most automobile bodies are painted in a single color wherein the basecoat is applied in a single spray operation. The coating is typically applied with pneumatic spray or rotary equipment producing a broad jet of paint droplets with a wide droplet size distribution. This has the advantage of producing a uniform high-quality coating in a relatively short time by an automated process.

However, this process has a number of disadvantages. If the vehicle body is to be painted with multiple colors, for example if a second color is used for a pattern such as a stripe, or if a whole section of the vehicle body such as the roof is painted a different color, this requires masking and then passing the vehicle body through the paint spray process a second time to add the second color. After this second paint operation the masking must be removed. This is both time-consuming and labor-intensive, adding significant cost to the operation.

A second disadvantage of the current spraying technology is that the droplets of paint are sprayed in a wide jet of droplets which has a wide range of droplet sizes. As a result, many of the droplets do not land on the vehicle, either because they are sprayed near edges and overspray the structure, or because the smaller droplets have too low a momentum to reach the vehicle body altogether. This excess overspray must be removed from the spray operation and disposed of safely, leading to significant generation of waste and also additional cost for wasted materials, clean up, disposal, etc.

Conventional inkjet inks have typically been formulated to print on porous structures such as paper and textiles where the ink is rapidly absorbed into the structures thus facilitating drying and handling of the structure shortly after printing. Although the printed articles have sufficient durability for these applications, such as printed text and pictures, or patterned fabrics, the durability requirements of an automotive coating are far greater in terms of both physical durability, such as resistance to abrasion and chipping, and long-term durability to weathering and light resistance. Furthermore, ink jet inks are typically formulated to have a low and generally shear-rate independent, or Newtonian, viscosity, typically below 20 cps. Such viscosity profiles are selected because of the limited amount of energy available in each nozzle of a printhead to eject a drop of ink, and also to avoid thickening of the ink in the channels of the printhead (e.g. from shear), which can lead to clogging.

By contrast, automotive coatings typically exhibit significant non-Newtonian shear behavior with extremely high viscosity at low shear to help avoid pigment settling and to ensure rapid and even set-up of the coating immediately after application, but relatively low viscosity at high shear rates to facilitate spraying and atomization of the spray into droplets.

Even if incumbent technology is suitable for use in some horizontal surface applications, other applications remain, such a vertical surface application, wherein the incumbent technology tends to sag to unacceptable levels. Since high transfer efficiency applicators demand very low viscosity with limited shear thinning behavior, standard approaches for imparting sag resistance for spray applied coatings cannot be employed.

More specifically, limitations imposed by high-resolution drop on demand (i.e., “inkjet” printheads) typically require that high shear viscosity be very low. In contrast with spray atomization, because evaporation of solvent does not occur after ejection of the paint from the applicator and prior to impacting the structure, viscosity buildup does not occur. Consequently, coatings may sag on non-horizontal surfaces. To achieve adequate sag resistance, rheology modifiers must be incorporated at such a high level that, while sag can be minimized, a yield stress prevents flow and leveling resulting in coating defects that are unique to zero overspray applicators. These defects include nozzle line and stripe overlap visibility. The former is due to incomplete flow and leveling of droplets emitted from adjacent nozzles resulting in visible and parallel lines in the direction of printhead movement. The latter is a result of application of a second stripe of paint (having width of the nozzle array) adjacent to a previously applied first stripe. While changing the index (distance between adjacent stripes) can improve the coalescence, with the high levels of rheology modifier required to prevent sag, the overlap region exhibits a visible peak or valley that cannot be eliminated by index optimization. In addition, due to particle size limitations for these small nozzle applicators, some rheology control agents cannot be used due to filter and nozzle clogging. Accordingly, there remains opportunity for improvement.

### BRIEF SUMMARY

This disclosure provides an aqueous coating composition including water, a crosslinker, and a resin dispersion comprising a latex, a polyurethane, or combinations thereof, wherein the composition is free of a thickener; wherein the composition is free of a thickener; wherein the composition exhibits a viscosity of less than or equal to about 100 cP, measured at a shear rate of from about 0.1 s⁻¹ to about 10 s⁻¹; and wherein the composition is visibly free of sag, determined by a 90-tilt test, when applied to and in direct contact with a partially dried coating substrate having a solids content of greater than about 80 wt %, based on a total weight of the coating substrate.

The disclosure further provides a method forming an article which includes the steps of providing a structure that has a surface; disposing a coating substrate on the surface of the structure; partially drying the coating substrate such that the coating substrate has a solids content of greater than about 80 wt %, based on a total weight of the coating substrate; providing the aqueous coating composition, and applying droplets of the aqueous coating composition onto the coating substrate.

Additionally, an article is also provided. The article includes the structure, the coating substrate disposed on the surface of the structure; and the aqueous coating composition disposed on and in contact with the coating substrate.

### BRIEF DESCRIPTION OF THE DRAWINGS

The present disclosure will hereinafter be described in conjunction with the following drawing figures, wherein like numerals denote like elements, and

FIG. 1 is a plot of viscosity as a function of sheer rate, resulting from a controlled shear rate flow sweep, measured according to ASTM7867-13, as published in 2024 illustrating the rheology profile of coating compositions 1-11 in the Examples.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to coating compositions, articles including the same and methods for utilizing the same. For the sake of brevity, conventional techniques related to making coating compositions may not be described in detail herein. Moreover, the various tasks and process steps described herein may be incorporated into a more comprehensive procedure or process having additional steps or functionality not described in detail herein. In particular, various steps in the manufacture of coating compositions are well-known and so, in the interest of brevity, many conventional steps will only be described briefly herein or will be omitted entirely without providing the well-known process details.

In this disclosure, the terminology “about” can describe values=0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values describe herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Composition:

This disclosure provides an aqueous coating composition that is free of a thickener. The composition may be further described as a waterborne coating composition, an aqueous coating, an aqueous basecoat, etc. Typically, the composition is defined as not an ink and different from an ink. The composition may be formulated and used as a one-component (i.e., “1K”) composition. Alternatively, the composition may be a two-component (i.e., “2K”) composition. The composition may be further described in rheology terminology, e.g. as a fluid having a near-Newtonian viscosity profile, with a relatively low and substantially shear-independent (“Newtonian”) low-shear viscosity, and an even lower and increasingly shear-dependent (non-Newtonian) high-shear viscosity.

The composition may be used for various applications. For example, the composition may be used for overspray-free applications and/or to provide good overlap appearance while maintaining low sag. Without being bound by theory, it is thought that the near-Newtonian viscosity profile of the composition can improve overlap performance, while maintaining good sag performance and still being suitable for drop-on-demand applications. These and other advantages will be understood in view of the embodiments and examples provided herein.

The aqueous composition may be, include, consist essentially of, or consist of, water, a crosslinker, and a resin dispersion, each as described below. In various embodiments, the terminology “consist essentially of” describes embodiments that are free of one or more solvents that are not water, cross-linkers that are not those described herein or those that are optional herein, resin dispersions that are not those described herein, polymers that are not those described herein and/or those described herein as optional, and/or any additives and/or optional components that are not described herein and/or are described herein as optional.

### Water:

The composition is an aqueous composition, i.e., the composition includes water, e.g. as a carrier, a solvent, a diluent, etc. The particular components of the composition and the application method may affect the amount of water in the composition. Accordingly, the water may be present in an amount that balances the weight of composition, e.g. to about 100 wt %. In various embodiments, the composition can include from about 30 to about 90 wt % of water, based on the total weight of the composition. In other embodiments, the composition includes from about 35 to about 85 wt %, about 40 to about 80 wt %, about 45 to about 75 wt %, about 50 to about 70 wt %, or about 55 to about 65 wt %, based on a total weight of the composition. In various embodiments, all values and ranges of values, both whole and fractional, including and between the aforementioned values, are hereby expressly contemplated for use herein.

In various embodiments, in addition to water, the composition further includes an additional solvent, such as an organic solvent. Non limiting examples of additional solvents include alcohols such as methanol, ethanol, propanol, etc., hydrocarbons such as toluene, xylene, hexane, etc.; ketones such as methyl ethyl ketone, acetone, etc.; esters such as ethyl acetate, butyl acetate, etc.; glycols such as ethylene glycol, propylene glycol monomethyl ether, etc. Typically, the additional solvent can be used in composition in a small amount, e.g. less than about 30 wt %, less than about 20 wt %, or less than about 10 wt %, based on the total weight of the composition. In various embodiments, the composition is free of solvents other than water. In various embodiments, all values and ranges of values, both whole and fractional, including and between the aforementioned values, are hereby expressly contemplated for use herein.

### Crosslinker:

The composition includes a crosslinker. The terminology “crosslinker” can be used to describe a compound having a reactive functional group, which can crosslink with, e.g. covalently bond to, a crosslinkable group, of a polymer, to produce a crosslinked structure. Non-limiting examples of reactive functional groups can include groups such as hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide, melamine, etc. and combinations thereof.

In various embodiments, the crosslinker is a melamine crosslinker. Suitable melamine crosslinkers may be melamine resins that are partially or fully etherified with one or more alcohols, typically methanol or butanol.

Examples of melamine crosslinkers may be or include monomeric melamine, polymeric melamine resins, and combinations thereof. In various embodiments, the monomeric melamine resin may include from about 3 to about 10 methylol groups etherized with a C₁ to C₅ monohydric alcohol, e.g. methanol, n-butanol, isobutanol per triazine nucleus, and combinations thereof. In various other embodiments, the monomeric melamine resin is highly methylated, e.g. in a weight ratio of the methyl to the methylol is from about 80:20 to about 99:1, e.g. about 85:15, about 90:10, about 95:5, etc. In various embodiments, all values and ranges of values, both whole and fractional, including and between the aforementioned values, are hereby expressly contemplated for use herein.

The monomeric melamine resin can typically have an average degree of polymerization of from about 1 to about 1.9, about 1.2 to about 1.8, or about 1.4 to about 1.6. Non limiting examples of monomeric melamine resins include alkylated melamines, such as methylated, butylated, isobutylated melamines and combinations thereof.

In one embodiment, the monomeric melamine resin has a degree of polymerization of about 1.5, and a methyl to methylol ratio of about 95:5. In another embodiment, the monomeric melamine resin has a degree of polymerization of about 1.6, and a methyl to methylol ratio of about 84:16.

The melamine crosslinker may also be or include a polymeric melamine resin. In various embodiments, the polymeric melamine resin is a methylated melamine formaldehyde resin, a hexamethoxymethyl melamine resin, or combinations thereof. In other embodiments, the polymeric melamine resin is a methylated high imino melamine crosslinker, a methylated n-butylated melamine crosslinker or a butylated melamine-formaldehyde with a high degree of alkylation and low methylol content, e.g. having an alkyl to methylol ratio of about 80:20 to about 99:1, e.g. about 85:15, about 90:10, about 95:5, etc. In various embodiments, all values and ranges of values, both whole and fractional, including and between the aforementioned values, are hereby expressly contemplated for use herein.

Other crosslinkers may also be utilized in the composition. For example, an isocyanate crosslinker may be utilized. Alternatively, both an isocyanate crosslinker and a melamine crosslinker can be used.

Examples of isocyanate crosslinkers are not particularly limited and may be any known in the art. In various embodiments, this isocyanate crosslinker is or includes an aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate.

In various embodiments, isocyanates such as oligomers derived from hexamethylene diisocyanate (HDI), diphenylmethane diisocyanate (MDI), isophorone diisocyanate (IPDI), or toluidine diisocyanate (TDI), e.g. isocyanurates, biuret, allophanates, and adducts of the isocyanates described above with polyhydric alcohols and mixtures thereof can be used as a crosslinker These can react with polyols such as, for example, OH group-containing polyesters, polyethers, acrylates and polyurethane, and mixtures thereof, which polyols may be solvent-based, solvent-free, or water-dilutable. Additionally, the isocyanate crosslinker may be a monofunctional isocyanate, a polyfunctional isocyanate, or combinations thereof.

Polyisocyanate-functional adducts can also be used in or as the crosslinker. Non-limiting examples of such adducts include an adduct of two molecules of a diisocyanate, such as hexamethylene diisocyanate or isophorone diisocyanate, and a diol such as ethylene glycol; an adduct of three molecules of hexamethylene diisocyanate and one molecule of water; an adduct of one molecule of trimethylol propane and three molecules of toluene diisocyanate; an adduct of one molecule of trimethylol propane and three molecules of isophorone diisocyanate or compounds, such as 1,3,5-triisocyanato benzene and 2,4,6-triisocyanatotoluene; an adduct of one molecule of pentaerythritol and four molecules of toluene diisocyanate, etc.

In various embodiments, the crosslinker is present in the composition in an amount of from about 1 to about 30, about 5 to about 25, about 10 to about 20, or about 10 to about 15 wt %, based on the total weight actives in the composition. In other embodiments, this amount is from about 1 to about 10, about 2 to about 9, about 3 to about 8, about 4 to about 7, or about 5 to about 6 wt %, based on a total weight of the composition. In various embodiments, all values and ranges of values, both whole and fractional, including and between the aforementioned values, are hereby expressly contemplated for use herein.

In various embodiments, the crosslinker is combination a melamine crosslinker and an isocyanate crosslinker.

### Resin Dispersion

The composition includes a resin dispersion that may be, include, consist essentially of, or consist of, a latex, a polyurethane, or combinations thereof. For example, the terminology “consist essentially of” may describe embodiments that are free of a latex, polyurethane, or any other polymer known in the art, wherein “free of” is as described above. The dispersion itself is a system in which distributed particles of one material are dispersed in a continuous phase of another material. The two phases may be in the same or different states of matter. Alternatively, the resin dispersion may be described as an emulsion which is a uniform mixture of two immiscible liquids. In the instant disclosure, the latex may include a polymer which may be a dispersed phase in a liquid continuous phase such as a water. Moreover, the polyurethane may be a dispersed or liquid continuous phase. Alternatively, combinations of the above may be used. If an emulsion, the emulsion may be any type known in the art, e.g. an o/w emulsion, w/o emulsion, etc. In various embodiments, water, a water-soluble co-solvent, such as any described herein, or a combination of water and one or more of such solvents can be used as a continuous phase wherein a dispersed phase may be the latex, the polyurethane, or combinations thereof.

In various embodiments, the resin dispersion is present in an amount of from about 1 to about 50, about 1 to about 45, about 1 to about 35, about 1 to about 30, about 1 to about 25, about 1 to about 20, about 1 to about 15, about 1 to about 10, about 1 to about 5, about 5 to about 50, about 10 to about 45, about 15 to about 40, about 20 to about 35, about 25 to about 30, about 15 to about 20, about 15 to about 25, about 15 to about 30, about 10 to about 20, about 10 to about 25, about 10 to about 30, about 10 to about 35, about 18 to about 22, about 18 to about 20, about 16 to about 20, about 16 to about 22, about 16 to about 24, etc., weight percent actives based on a total weight of the composition. In various non-limiting embodiments, all values and ranges of values, both whole and fractional, including and between the aforementioned values, are hereby expressly contemplated for use herein.

### Latex:

It is contemplated that zero, one, two, three, four, five, or even more individual latexes may be used in the composition. In various embodiments, the terminology “latex” means a dispersion of polymer particles in water. For example, a latex polymer typically requires a secondary dispersing agent (e.g., a surfactant) for creating a dispersion or emulsion of polymer particles in water. The latex is not particularly limited and may be any known in the art.

In various embodiments, the latex may be, include, consist essentially of, or consist of the reaction product of one or more of the following monomers to form a polymer which may be a dispersed phase and/or a continuous phase. These monomers may include, but are not limited to, (meth)acrylamide, N-substituted (meth)acrylamide, octyl(meth)acrylate, nonylphenol ethoxylate(meth)acrylate, isononyl(meth)acrylate, 1,6-hexanediol(meth)acrylate, isobornyl(meth)acrylate, 2-(2-ethoxyethoxy)ethyl(meth)acrylate, 2-ethylhexyl(meth)acrylate, lauryl(meth)acrylate, beta-carboxyethyl(meth)acrylate, isobutyl(meth)acrylate, cycloaliphatic epoxide, alpha-epoxide, 2-hydroxyethyl(meth)acrylate, (meth)acrylonitrile, maleic anhydride, itaconic acid, isodecyl(meth)acrylate, dodecyl(meth)acrylate, n-butyl(meth)acrylate, methyl(meth)acrylate, hexyl(meth)acrylate, (meth)acrylic acid, N-vinylcaprolactam, stearyl(meth)acrylate, hydroxy functional caprolactone ester (meth)acrylate, octodecyl(meth)acrylate, isooctyl(meth)acrylate, hydroxyethyl(meth)acrylate, hydroxymethyl(meth)acrylate, hydroxypropyl(meth)acrylate, hydroxyisopropyl(meth)acrylate, hydroxybutyl(meth)acrylate, hydroxyisobutyl(meth)acrylate, tetrahydrofurfuryl(meth)acrylate, combinations of these, and the like.

In other embodiments, the latex may be, include, consist essentially of, or consist of one or more of (meth)acrylated urethanes (i.e., urethane (meth)acrylates),(meth)acrylated epoxies (i.e., epoxy (meth)acrylates), (meth)acrylated polyesters (i.e., polyester (meth)acrylates), (meth)acrylated (meth)acrylics, (meth)acrylated silicones, (meth)acrylated amines, (meth)acrylated amides; (meth)acrylated polysulfones; (meth)acrylated polyesters, (meth)acrylated polyethers (i.e., polyether (meth)acrylates), vinyl(meth)acrylates, and (meth)acrylated oils.

In one embodiment, the resin dispersion may be, include, consist essentially of, or consist of, a polyester-modified acrylic dispersion containing epoxy groups. One non-limiting example has a trade name of Daotan® VTW 1686/40WA which is commercially available from Allnex.

In another embodiment, the resin dispersion may be, include, consist essentially of, or consist of, a styrene-acrylic latex dispersion. This dispersion may be formed by a two-step emulsion polymerization process.

In one embodiment, the resin dispersion may be, include, consist essentially of, or consist of, the latex. In various embodiments, the latex is present in an amount of from about 1 to about 100, about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55, weight percent actives based on a total weight of the dispersion. In other embodiments, the latex (e.g. individually or as a whole) is present in an amount of from about 1 to about 50, about 1 to about 45, about 1 to about 35, about 1 to about 30, about 1 to about 25, about 1 to about 20, about 1 to about 15, about 1 to about 10, about 1 to about 5, about 5 to about 50, about 10 to about 45, about 15 to about 40, about 20 to about 35, about 25 to about 30, about 15 to about 20, about 15 to about 25, about 15 to about 30, about 10 to about 20, about 10 to about 25, about 10 to about 30, about 10 to about 35, about 18 to about 22, about 18 to about 20, about 16 to about 20, about 16 to about 22, about 16 to about 24, etc., weight percent actives based on a total weight of the composition. In other embodiments, the latex (either individually or as a whole) is present in an amount of from about 1 to about 30, about 3 to about 30, about 3 to about 25, 1 to about 20, about 2 to about 19, about 3 to about 18, about 4 to about 17, about 5 to about 16, about 6 to about 15, about 7 to about 14, about 8 to about 13, about 9 to about 12, about 10 to about 11, or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, weight percent actives based on a total weight of the composition. In various non-limiting embodiments, all values and ranges of values, both whole and fractional, including and between the aforementioned values, are hereby expressly contemplated for use herein.

### Polyurethane:

The resin dispersion may also be, include, consist essentially of, or consist of, the polyurethane. It is contemplated that zero, one, two, three, four, five, or even more individual polyurethanes may be used in the composition. The polyurethane is not particularly limited and may be any known in the art. In various embodiments, the polyurethane is the reaction product of a polyol and an isocyanate.

In various embodiments, the polyol is chosen from polyester polyols, polyether polyols, and polycarbonate polyols. It is also contemplated that polythioether polyols, polycaprolactones, and acrylic polyols may also be utilized. In one embodiment, the polyol is further defined as a polyester polyol. In another embodiment, the polyol is a polyester polyol. In another embodiment, the polyol, is an aromatic polyester or polyether polyol.

The polyol may be derived from a reaction of an initiator and an alkylene oxide. The initiator may include any initiator known in the art. In various embodiment, the initiator is chosen from ethylene glycol, propylene glycol, dipropylene glycol, trimethylene glycol, butane diols, pentane diols, hexane diols, heptane diols, glycerol, 1,1,1-trimethylolpropane, 1,1,1-trimethylolethane, hexane triols, alkyl glucosides, pentaerythritol, sorbitol, diamine naphthalenes, anilines, condensation products of aniline and formaldehyde, alkyl amines, triisopropanolamine, alkylene diamines, diamine alkanes, sucrose, toluene diamine, and combinations thereof.

The alkylene oxide that reacts with the initiator to form the polyol may be chosen from ethylene oxide, propylene oxide, butylene oxide, amylene oxide, tetrahydrofuran, alkylene oxide-tetrahydrofuran mixtures, epihalohydrins, aralkylene oxides, and combinations thereof. In various embodiments, the alkylene oxide is chosen from ethylene oxide, propylene oxide, and combinations thereof. However, it is also contemplated that any suitable alkylene oxide that is known in the art may be used.

The polyol may include an organic functional group chosen from a carboxyl group, an amine group, a carbamate group, an amide group, and an epoxy group. The polyol may also include an alkylene oxide cap. If the polyol includes the alkylene oxide cap, the alkylene oxide cap typically includes, but is not limited to, ethylene oxide, propylene oxide, butylene oxide, amylene oxide, and combinations thereof. More typically, the alkylene oxide cap includes ethylene oxide. If the polyol includes the alkylene oxide cap, the alkylene oxide cap may be less than or equal to 25, and more typically of from 10 to 20, percent by weight based on the total weight of the polyol. In various non-limiting embodiments, all values and ranges of values, both whole and fractional, including and between the aforementioned values, are hereby expressly contemplated for use herein.

In various embodiments, the polyol has a number average molecular weight of from 200 to 10,000 g/mol, a hydroxyl number of from 10 to 1,000 mg KOH/g, and a nominal functionality of from 1 to 8. In various embodiments, the polyol also typically has a viscosity from 20 to 50,000 centipoises at 77° F. In various non-limiting embodiments, all values and ranges of values, both whole and fractional, including and between the aforementioned values, are hereby expressly contemplated for use herein.

The polyol may also include an addition polymer dispersed therein. More specifically, the polyol may include a dispersion or a solution of addition or condensation polymers, i.e., a graft polyol. The dispersion may include styrene, acrylonitrile, and combinations thereof. Also, the polyol may also include an emulsion that includes water or any other polar compound known in the art.

Alternatively, the polyurethane may be described as the reaction product of a compound having one or more hydroxyl groups (e.g. a monol, diol, triol, tetrol, or polyol) and an isocyanate. Non-limiting suitable compounds include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. If desired, monohydric alcohols, such as, for example, butanol, octanol, lauryl alcohol, ethoxylated or propoxylated phenols may also be included along with polyhydric alcohols to control molecular weight.

In certain embodiments, low molar mass polyols defined by an empirical and structural formula, such as polyhydric alcohols are utilized to form the polyurethane. Non-limiting examples of polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. In other embodiments, oligomeric or polymeric polyols with number-average molar masses of, for example, up to 8000, alternatively up to 5000, alternative up to 2000, and/or, for example, corresponding hydroxyl-functional polyethers, polyesters or polycarbonates are utilized. In various non-limiting embodiments, all values and ranges of values, both whole and fractional, including and between the aforementioned values, are hereby expressly contemplated for use herein.

An isocyanate may also be reacted with a hydroxyl-functional resin that is not particularly limited and may be any known in the art. In various embodiments, this resin may be, include, consist essentially of, or consist of, aliphatic or aromatic dicarboxylic acids, polyols, diols, aromatic or aliphatic cyclic anhydrides and cyclic alcohols. Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

Non-limiting suitable polyhydric alcohols include ethylene glycol, propanediols, butanediols, hexanediols, neopentylglycol, diethylene glycol, cyclohexanediol, cyclohexanedimethanol, trimethylpentanediol, ethylbutylpropanediol, ditrimethylolpropane, trimethylolethane, trimethylolpropane, glycerol, pentaerythritol, dipentaerythritol, polyethylene glycol and polypropylene glycol. If desired, monohydric alcohols, such as, for example, butanol, octanol, lauryl alcohol, ethoxylated or propoxylated phenols may also be included along with polyhydric alcohols. Alternatively, low molar mass polyols defined by an empirical and structural formula, such as polyhydric alcohols can be utilized. In other embodiments, oligomeric or polymeric polyols with number-average molar masses of, for example, up to 8000, alternatively up to 5000, alternative up to 2000, and/or, for example, corresponding hydroxyl-functional polyethers, polyesters or polycarbonates are utilized. In various non-limiting embodiments, all values and ranges of values, both whole and fractional, including and between the aforementioned values, are hereby expressly contemplated for use herein.

The resin dispersion may also include an amine, which may be any type known in the art, that may or may not react with an isocyanate to form a polyurea. The amine may include, but is not limited to, primary and secondary amines aliphatic and/or cyclic aliphatic amines. The amine may include any additional functional group known in the art including, but not limited to, hydroxyl groups, thiol groups, alkyl groups, cyclic groups, aromatic groups, and combinations thereof. It is to be understood that the amine may also include an amide which also may be any type known in the art. The amide may include, but is not limited to, polyester amides obtained from polymers of unsaturated or saturated carboxylic acids or anhydrides, and multifunctional unsaturated or saturated amino-alcohols, and combinations thereof.

Referring back to the isocyanate, the isocyanate is not particularly limited and may be any described in this disclosure. In various embodiment, the isocyanate includes at least one isocyanate and may include more than one isocyanate. The isocyanate may be, include, consist essentially of, or consist of an aromatic isocyanate, an aliphatic isocyanate, and/or combinations thereof. In one embodiment, the isocyanate is or includes an aromatic isocyanate such as polymeric MDI. If the isocyanate is or includes an aromatic isocyanate, the aromatic isocyanate typically corresponds to the formula R′ (NCO) z wherein R′ is a polyvalent organic radical which is aromatic and z is an integer that corresponds to the valence of R′. Typically, z is at least two.

In various embodiments, isocyanate may be, include, consist essentially of, or consist of 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof.

If the isocyanate is or includes an aromatic isocyanate, the isocyanate may be, include, consist essentially of, or consist of a modified multivalent aromatic isocyanate, i.e., a product which is obtained through chemical reactions of aromatic diisocyanates and/or aromatic polyisocyanates. Examples include polyisocyanates including, but not limited to, ureas, biurets, allophanates, carbodiimides, uretonimines, and isocyanurate and/or urethane groups including diisocyanates and/or polyisocyanates such as modified diphenylmethane diisocyanates. The urethane groups of the isocyanate may be formed through reaction of a base isocyanate, as described above, with low molecular weight diols, triols, dialkylene glycols, trialkylene glycols, polyoxyalkylene glycols with a number average molecular weight of up to 1500 g/mol, diethylene glycol, dipropylene glycol, polyoxyethylene glycol, polyoxypropylene glycol, polyoxyethylene glycol, polyoxypropylene glycol, and/or polyoxypropylene polyoxyethylene glycols or triols, and combinations thereof. The isocyanate may also include one or more prepolymers including isocyanate groups.

The isocyanate may be, include, consist essentially of, or consist of modified benzene and toluene diisocyanates, employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof. In various embodiments, the isocyanate may be, include, consist essentially of, or consist of an isocyanate that is chosen from 2,4′-diphenylmethane diisocyanate, 4,4′-diphenylmethane diisocyanate, modified 2,4′-diphenylmethane diisocyanate, modified 4,4′-diphenylmethane diisocyanate, and combinations thereof. The isocyanate composition may also include stoichiometric or non-stoichiometric reaction products of the aforementioned isocyanates.

Alternatively, the isocyanate may be, include, consist essentially of, or consist of a liquid polyisocyanate including one or more carbodiimide groups. In various embodiments, crude polyisocyanates may also be used, such as crude toluene diisocyanate obtained by the phosgenation of a mixture of toluenediamines or crude diphenylmethane isocyanate obtained by the phosgenation of crude isocyanates.

The isocyanate is not limited in NCO content and typically has an NCO content of from 5 to 35 percent by weight. Determination of the NCO content on percent by weight is accomplished by a standard chemical titration analysis known to those skilled in the art. In various non-limiting embodiments, all values and ranges of values, both whole and fractional, including and between the aforementioned values, are hereby expressly contemplated for use herein.

In still other embodiments, non-limiting examples of suitable polyisocyanates include aromatic, aliphatic or cycloaliphatic di-, tri- or tetra-isocyanates, including polyisocyanates having isocyanurate structural units, such as, the isocyanurate of hexamethylene diisocyanate and isocyanurate of isophorone diisocyanate; the adduct of two molecules of a diisocyanate, such as, hexamethylene diisocyanate and a diol such as, ethylene glycol; uretidiones of hexamethylene diisocyanate; uretidiones of isophorone diisocyanate or isophorone diisocyanate; the adduct of trimethylol propane and meta-tetramethylxylene diisocyanate. Other polyisocyanates disclosed herein can also be suitable for producing polyurethanes.

Other polyurethanes can be made by first forming an NCO-functional hydrophilic polyurethane prepolymer by addition reaction of polyol type compounds and polyisocyanates, conversion of the so-formed polyurethane prepolymer into the aqueous phase and then reacting the aqueously dispersed NCO-functional polyurethane prepolymer with an NCO-reactive chain extender like, for example, a polyamine, a hydrazine derivative or water.

In other embodiments, the polyurethane may be, include, consist essentially of, or consists of, a polyester-polyurethane polymer. The polyester of the polyester-polyurethane polymer may be linear or branched. Useful polyesters can include esterification products of aliphatic or aromatic dicarboxylic acids, polyols, diols, aromatic or aliphatic cyclic anhydrides and cyclic alcohols. Non-limiting examples of suitable cycloaliphatic polycarboxylic acids are tetrahydrophthalic acid, hexahydrophthalic acid, 1,2-cyclohexanedicarboxylic acid, 1,3-cyclohexanedicarboxylic acid, 1,4-cyclohexanedicarboxylic acid, 4-methylhexahydrophthalic acid, endomethylenetetrahydrophthalic acid, tricyclodecanedicarboxylic acid, endoethylenehexahydrophthalic acid, camphoric acid, cyclohexanetetracarboxylic, and cyclobutanetetracarboxylic acid. The cycloaliphatic polycarboxylic acids can be used not only in their cis but also in their trans form and as a mixture of both forms. Further non-limiting examples of suitable polycarboxylic acids can include aromatic and aliphatic polycarboxylic acids, such as, for example, phthalic acid, isophthalic acid, terephthalic acid, halogenophthalic acids, such as, tetrachloro- or tetrabromophthalic acid, adipic acid, glutaric acid, azelaic acid, sebacic acid, fumaric acid, maleic acid, trimellitic acid, and pyromellitic acid. Combinations of polyacids, such as a combination of polycarboxylic acids and cycloaliphatic polycarboxylic acids can be suitable. Combinations of polyols can also be suitable.

Non-limiting examples of suitable polyesters include a branched copolyester polymer. The branched copolyester polymer and process for production described in U.S. Pat. No. 6,861,495, which is hereby incorporated by reference, can be suitable. Monomers with multifunctional groups such as AxBy (wherein each of x and y is independently 1 to 3) types including those having one carboxyl group and two hydroxyl groups, two carboxyl groups and one hydroxyl group, one carboxyl group and three hydroxyl groups, or three carboxyl groups and one hydroxyl group can be used to create branched structures. Non-limiting examples of such monomers include 2,3 dihydroxy propionic acid, 2,3 dihydroxy 2-methyl propionic acid, 2,2 dihydroxy propionic acid, 2,2-bis(hydroxymethyl) propionic acid, and the like.

The branched copolyester polymer can be conventionally polymerized from a monomer mixture containing a chain extender chosen from a hydroxy carboxylic acid, a lactone of a hydroxy carboxylic acid, and a combination thereof; and one or more branching monomers. Some of the suitable hydroxy carboxylic acids include glycolic acid, lactic acid, 3-hydroxypropionic acid, 3-hydroxybutyric acid, 3-hydroxyvaleric acid, and hydroxypyvalic acid. Some of the suitable lactones include caprolactone, valerolactone; and lactones of the corresponding hydroxy carboxylic acids, such as, e.g., 3-hydroxypropionic acid, 3-hydroxybutyric acid, 3-hydroxyvaleric acid, and hydroxypyvalic acid. In certain embodiments, caprolactone can is utilized. In embodiments, the branched copolyester polymer can be produced by polymerizing, in one step, the monomer mixture that includes the chain extender and hyper branching monomers, or by first polymerizing the hyper branching monomers followed by polymerizing the chain extenders. It is to be appreciated that the branched copolyester polymer can be formed from acrylic core with extending monomers described above.

The polyester-polyurethane polymer can be produced from the polyester and polyisocyanates. The polyester can be polymeric or oligomeric organic species with at least two hydroxyl-functionalities or two-mercapto functionalities and their mixtures thereof. Polyesters and polycarbonates with terminal hydroxy groups can be effectively used as the diols.

One non-limiting example of a polyester-polyurethane polymer is a polyurethane dispersion resin formed from a linear polyester diol resin (reaction product of monomers 1,6-hexanediol, adipic acid, and isophthalic acid) and isophorone diisocyanate. This polyester-polyurethane polymer has a weight average molecular weight of about 30,000, a solids content of about 35 wt %, and a particle size (e.g. Dv50) of about 250 nanometers, as determined using any apparatus known in the art, e.g. a Malvern Mastersizer.

Another non-limiting example of a polyester-polyurethane polymer is a polyurethane dispersion resin formed from a linear polycarbonate-polyester and isophorone diisocyanate. This polyester-polyurethane polymer has a weight average molecular weight of about 75,000, a solids content of about 35 wt %, and a particle size (e.g. Dv50) of about 180 nanometers, as determined using any apparatus known in the art, e.g. a Malvern Mastersizer.

In another embodiment, the resin dispersion may be, include, consist essentially of, or consist of, a polyurethane dispersion resin formed from a slightly branched polyester polyol and hexamethylene diisocyanate, e.g. being about 40 wt % solid.

In a further embodiment, the resin dispersion may be, include, consist essentially of, or consist of, a polyurethane dispersion resin formed from a linear polyester diol resin (e.g. that is the reaction product of monomers 1,6-hexanediol, adipic acid, and isophthalic acid) and isophorone diisocyanate, e.g. being about 35 wt % solid.

In another embodiment, the polyurethane is chosen from one formed from a branched polyester polyol and hexamethylene diisocyanate; formed from a linear polyester diol resin and isophorone diisocyanate wherein the linear polyester diol is the reaction product of 1,6-hexanediol, adipic acid, and isophthalic acid; formed from a linear polycarbonate-polyester polyol and isophorone diisocyanate; a polyester-polyurethane polymer; and combinations thereof.

In another embodiment, the resin dispersion may be, include, consist essentially of, or consist of, a polyurethane dispersion resin formed from a linear polycarbonate-polyester polyol and isophorone diisocyanate.

In still another embodiment, the resin dispersion may be, include, consist essentially of, or consist of, a polyester-polyurethane polymer having the tradename Bayhydrol® U 241 which is commercially available from Covestro AG of Leverkusen, Germany.

In one embodiment, the resin dispersion may be, include, consist essentially of, or consist of, the polyurethane. In various embodiments, the polyurethane is present in an amount of from about 1 to about 100, about 5 to about 95, about 10 to about 90, about 15 to about 85, about 20 to about 80, about 25 to about 75, about 30 to about 70, about 35 to about 65, about 40 to about 60, about 45 to about 55, or about 50 to about 55, weight percent actives based on a total weight of the dispersion. In various embodiments, this amount is from about 30 to about 50, e.g., 31, 32, 33, 34, 35, 36, 37, 38, 39, 40, 41, 42, 43, 44, 45, 46, 47, 48, 49, or 50, weight percent actives based on a total weight of the dispersion. In other embodiments, the polyurethane (e.g. individually or as a whole) is present in an amount of from about 1 to about 50, about 1 to about 45, about 1 to about 35, about 1 to about 30, about 1 to about 25, about 1 to about 20, about 1 to about 15, about 1 to about 10, about 1 to about 5, about 5 to about 50, about 10 to about 45, about 15 to about 40, about 20 to about 35, about 25 to about 30, about 15 to about 20, about 15 to about 25, about 15 to about 30, about 10 to about 20, about 10 to about 25, about 10 to about 30, about 10 to about 35, about 18 to about 22, about 18 to about 20, about 16 to about 20, about 16 to about 22, about 16 to about 24, etc., weight percent actives based on a total weight of the composition. In various embodiments, this amount is from about 1 to about 15, e.g. 1, 2, 3, 4, 5, 6, 7, 8, 9, 10, 11, 12, 13, 14, or 15, weight percent actives based on a total weight of the composition. In other embodiments, the polyurethane (either individually or as a whole) is present in an amount of from about 1 to about 20, about 2 to about 19, about 3 to about 18, about 4 to about 17, about 5 to about 16, about 6 to about 15, about 7 to about 14, about 8 to about 13, about 9 to about 12, about 10 to about 11, or about 1, 2, 3, 4, 5, 6, 7, 8, 9, 10, 11, 12, 13, 14, 15, 16, 17, 18, 19, or 20, weight percent actives based on a total weight of the composition. In various non-limiting embodiments, all values and ranges of values, both whole and fractional, including and between the aforementioned values, are hereby expressly contemplated for use herein.

In various embodiments, the resin dispersion can include core-shell particles that includes a polymeric core, urethane linkages, and carboxylic acid and hydroxyl functional groups. In other embodiments, the core-shell particles include a polymeric core at least partially encapsulated by a polymeric shell including the urethane linkages and carboxylic acid and hydroxyl functional groups, wherein the polymeric shell is covalently bonded to at least a portion of the polymeric core. In still other embodiments, at least a portion of the polymeric core of the core-shell particles includes an addition polymer formed from (meth)acrylic monomers, vinyl monomers, or combinations thereof. In additional embodiments, the core-shell particles includes urea linkages and urethane linkages and with keto functionality on the acrylic core and carboxylic acid functionality on the polyurethane shell.

Without being bound by theory, it is believed that utilizing the resin dispersion, e.g. as a binder, in the composition can help maintain a viscosity profile that is otherwise achieved by adding rheology additives such as a thickener. Furthermore, the resin dispersion can help form a smooth, level layer of the composition during application processes.

### Free of Thickener:

As first described above, the composition is free of a thickener. In general, coatings may include a thickener to attain certain rheological properties. In general, as understood by a skilled person, a thickener can be a rheology control agent, i.e., rheology modifier, thixotropic agent, etc., which may be synthetic or natural, and organic or inorganic, etc. Therefore, the terminology “free of a thickener” may mean that the composition is free of any one of or combinations of thickeners, rheology control agents, thickening agent, rheology additives, etc.

In particular, synthetic organic thickeners such as hydrophobically modified ethoxylated urethane (HEUR), hydrophobically modified alkali swellable emulsion (HASE), epoxy-functionalized polyurethane, epoxy-functionalized acrylic, hydrophobically modified polyacrylate thickener, a hydrophobically modified polyether thickener, and a hydrophobically modified cellulose ether, etc. are well-known in the art. Thus, the composition may be more specifically described as free of HEUR thickener, free of HASE thickener, etc.

In various embodiments, the terminology “free of” means that composition includes 0 wt % of a thickener. However, as understood by a skilled person, a trace amount of a thickener, e.g. as a contaminant, minor impurities in various components, etc. may be present in the composition, in a trace amount of less than about 0.4 wt %, alternatively less than about 0.3 wt %, less than about 0.2 wt %, less than 0.1 wt %, less than 0.05 wt %, or less than about 0.01 wt %. In various embodiments, all values and ranges of values, both whole and fractional, including and between the aforementioned values, are hereby expressly contemplated for use herein.

### Additional and Optional Components

The composition can include, or be free of, one or more various additives, such as binders, dyes, additional rheology modifiers, carriers, catalysts, conventional additives, or combinations thereof. Conventional additives may include, but are not limited to, dispersants, antioxidants, UV stabilizers and absorbers, surfactants, wetting agents, leveling agents, antifoaming agents, anti-cratering agents, or combinations thereof. In some embodiments, the composition includes one or more of a pigment; a cosolvent; a catalyst; a UV absorber; a leveling additive; a wetting additive; or a combination of any of these.

In some embodiments, the composition includes a pigment. Any pigment known in the art for use in compositions may be utilized in the composition, so long as the other parameters of the composition are achieved.

In various embodiments, the composition may include the pigment or be free of the pigment. Any pigment known in the art for use in compositions may be utilized in the composition. Non-limiting examples of suitable pigments include metallic oxides, metal hydroxide, effect pigments including metal flakes, chromates, such as lead chromate, sulfides, sulfates, carbonates, carbon black, silica, talc, china clay, phthalocyanine blues and greens, organo reds, organo maroons, pearlescent pigments, other organic pigments and dyes, and combinations thereof. If desired, chromate-free pigments, such as barium metaborate, zinc phosphate, aluminum triphosphate and combinations thereof, can also be utilized.

The composition may include the pigment in an amount of from about 0 to about 50, alternatively from about 1 to about 20, or alternatively from about 1 to about 10 wt. %, based on a total weight of the composition. In other embodiments, the optional pigment is present in an amount of from about 1 to about 50, about 5 to about 50, about 10 to about 45, about 15 to about 40, about 20 to about 35, or about 25 to about 30, weight percent actives based on a total weight of the composition. In other embodiments, the optional pigment is present in an amount of from about 1 to about 20, about 2 to about 19, about 3 to about 18, about 4 to about 17, about 5 to about 16, about 6 to about 15, about 7 to about 14, about 8 to about 13, about 9 to about 12, about 10 to about 11, or about 1, 2, 3, 4, 5, 6, 7, 8, 9, 10, 11, 12, 13, 14, 15, 16, 17, 18, 19, or 20, weight percent actives based on a total weight of the composition. In other embodiments, the optional pigment is present in an amount of from about 0.1 to about 1, about 0.2 to about 0.9, about 0.3 to about 0.8, about 0.4 to about 0.7, about 0.5 to about 0.6, or about 0.1, 0.2, 0.3, 0.4, 0.5, 0.6, 0.7, 0.8, 0.9, or 1.0, weight percent actives based on a total weight of the composition. In various non-limiting embodiments, all values and ranges of values, both whole and fractional, including and between the aforementioned values, are hereby expressly contemplated for use herein.

The composition may also include a cosolvent, i.e., any organic or solvent compatible with the aqueous composition. Non-limiting examples of suitable organic solvents may include aromatic hydrocarbons; ketones, such as, acetone, methyl ethyl ketone, methyl isobutyl ketone, methyl amyl ketone and diisobutyl ketone; esters, such as, ethyl acetate, n-butyl acetate, isobutyl acetate, and a combination thereof. In some embodiments, the evaporation rate of the solvent may have an impact on the suitability of the composition for printing. Certain co-solvents may be incorporated into the composition having increased or decreased evaporation rates thereby increasing or decreasing the evaporation rate of the composition. Typically, the composition is free from, alternatively substantially free from, volatile organic solvents.

In some embodiments, the cosolvent is chosen from water-soluble solvents. In various embodiments, the water-soluble solvent may be methanol, propanol, butanol, ethanol, 1,2-butanediol, 1,3-butanediol, 1,3-propanediol, 1,4-butanediol, 1,4-dioxane, 1,5-pentanediol, 2-butoxyethanol, 2-propanol, acetaldehyde, acetic acid, acetone, acetonitrile, butyric acid, diethanolamine, diethylenetriamine, dimethyl sulfoxide, dimethoxyethane, dimethylformamide, ethylamine, ethylene glycol, formic acid, furfuryl alcohol, glycerol, methyl diethanolamine, methyl isocyanide, n-methyl-2-pyrrolidone, propanoic acid, propylene glycol, pyridine, tetrahydrofuran, triethylene glycol, glycol ethers (ethylene glycol monobutyl ether, diethylene glycol monobutyl ether, etc., any and all isomers thereof, or combinations thereof. Alternatively, the composition may be free of any one or more of the aforementioned solvents so long as at least one water-soluble solvent is utilized in the composition. In some embodiments, for example, the composition is substantially free from small-chain alcohols.

In various embodiments, the cosolvent, including any one or more of the additional solvents selected for use, is present in an amount of from about 0 to about 25, about 0.5 to about 25, about 2 to about 19, about 3 to about 18, about 4 to about 17, about 5 to about 16, about 6 to about 15, about 7 to about 14, about 8 to about 13, about 9 to about 12, about 10 to about 11, or about 1, 2, 3, 4, 5, 6, 7, 8, 9, 10, 11, 12, 13, 14, 15, 16, 17, 18, 19, or 20, weight percent actives based on a total weight of the composition. In various non-limiting embodiments, all values and ranges of values, both whole and fractional, including and between the aforementioned values, are hereby expressly contemplated for use herein.

The composition may further include a catalyst. The composition may further include a catalyst to reduce curing time and to allow curing of the composition at ambient or elevated temperatures. The ambient temperatures are typically referred to as temperatures in a range of from about 18° C. to about 35° C. Non-limiting examples of suitable catalysts may include organic metal salts, such as, dibutyl tin dilaurate, dibutyl tin diacetate, dibutyl tin dichloride, dibutyl tin dibromide, zinc naphthenate; triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts and other catalysts, or a combination thereof. Non-limiting examples of suitable acid catalysts may include carboxylic acids, sulfonic acids, phosphoric acids or a combination thereof. In some embodiments, the acid catalyst can include, for example, acetic acid, formic acid, dodecyl benzene sulfonic acid, dinonyl naphthalene sulfonic acid, para-toluene sulfonic acid, phosphoric acid, or a combination thereof. The composition may include the catalysts in an amount of from about 0.01 to about 5, alternatively from about 0.01 to about 1, or alternatively from about 0.02 to about 0.5 wt. %, based on a total weight of the composition.

The composition may further include other additives known in the art such as wetting agents, leveling and flow control agents, for example, Resiflow®S (polybutylacrylate), BYK® 320 and 325 (high molecular weight polyacrylates), BYK® 347 (polyether-modified siloxane) under respective trade names, leveling agents based on (meth)acrylic homopolymers; rheological control agents; thickeners, such as partially crosslinked polycarboxylic acid or polyurethanes; and antifoaming agents. The other additives can be used in conventional amounts familiar to those skilled in the art. In embodiments, the wetting agents, leveling agents, flow control agents, and surfactants of the composition can affect the surface tension of the composition and thus may have an impact on the suitability of the composition for printing. Certain wetting agents, leveling agents, flow control agents, and surfactants may be incorporated into the composition for increasing or decreasing the surface tension of the composition.

The composition may include, or be free of, a UV absorber. Non-limiting examples of UV absorbers include hydroxyphenyl benzotriazoles, such as, 2-(2-hydroxy-5-methylphenyl)-2H-benzotrazole, 2-(2-hydroxy-3,5-di-tert.amyl-phenyl)-2H-benzotriazole, 2 [2-hydroxy-3,5-di(1,1-dimethylbenzyl)phenyl]-2H-benzotriazole, reaction product of 2-(2-hydroxy-3-tert.butyl-5-methyl propionate)-2H-benzotriazole and polyethylene ether glycol having a weight average molecular weight of 300, 2-(2-hydroxy-3-tert.butyl-5-iso-octyl propionate)-2H-benzotriazole; hydroxyphenyl s-triazines, such as, 2-[4 ((2,-hydroxy-3-dodecyloxy/tridecyloxypropyl)-oxy)-2-hydroxyphenyl]-4,6-bis(2,4-dimethylphenyl)-1,3,5-triazine, 2-[4 (2-hydroxy-3-(2-ethylhexyl)-oxy)-2-hydroxyphenyl]-4,6-bis(2,4-dimethylphenyl) 1,3,5-triazine, 2-(4-octyloxy-2-hydroxyphenyl)-4,6-bis(2,4-dimethylphenyl)-1,3,5-triazine; hydroxybenzophenone U.V. absorbers, such as, 2,4-dihydroxybenzophenone, 2-hydroxy-4-octyloxybenzophenone, and 2-hydroxy-4-dodecyloxybenzophenone.

### Physical Properties:

The composition is not particularly limited relative to solids content and may have a solids content of from about 5 to about 90, alternatively from 5 to about 80, about 15 to about 70 wt. %, about 15 to about 30, about 10 to about 35, or about 20 to about 25 wt. %. based on a weight of the composition. In other embodiments, the solids content is from about 5 to about 85, about 10 to about 80, about 15 to about 75, about 20 to about 70, about 25 to about 65, about 30 to about 60, about 35 to about 55, about 40 to about 50, or about 45 to about 50 wt. %, based on a weight of the composition. In various non-limiting embodiments, all values and ranges of values, both whole and fractional, including and between the aforementioned values, are hereby expressly contemplated for use herein. The solids content may be determined in accordance with ASTM D2369-10, as published in 2024. In certain embodiments, the higher solids content for the composition may be desired due to the composition not undergoing atomization utilizing conventional spray equipment.

The composition can exhibit a near-Newtonian viscosity profile as described above. Viscosity of the composition may be determined according to any standard method, using any apparatus, any instrument, etc. known in the art. In various embodiments, the viscosity is measured using an Efflux cup, a rotational viscometer, a capillary viscometer, a stormer viscometer, etc. In other embodiments, the viscosity may be measured according to a standardized test, e.g. ASTM D562, ASTM D1200, ASTM D2196, as published in 2024, etc. In various embodiments, a standardized method such as ASTM 7867-13 as published in 2024 with cone-and-plate or parallel plates at various sheer rates is utilized to measure the viscosity of the composition.

The composition exhibits a viscosity which may vary depending on the solids content, various components and their amounts included in the composition. The viscosity, measured using any one of the aforementioned methods, is less than or equal to about 100 cP at a shear rate of from 0.1 s⁻¹ to 10 s⁻¹. In some embodiments, the composition exhibits a viscosity of from about 10 to about 90, about 20 to about 80, about 30 to about 70, about 40 to about 60, or about 40 to about 50 cP at a shear rate of from 0.1 s⁻¹ to 10 s⁻¹. In some embodiments, the composition exhibits a viscosity of less than or equal to about 90, 85, 80, 75, 70, 65, 60, 55, 50, 45, 40, 35, 30, 25, 20, or 15, cP, measured at a shear rate of from about 0.1 s⁻¹ to about 10 s⁻¹. In yet other embodiments, the composition exhibits a viscosity of less than or equal to about 10, 9, 8, 7, 6, 5, 4, 3, 2, or 1, cP, measured at a shear rate of from about 0.1 s⁻¹ to about 10 s⁻¹. In various non-limiting embodiments, all values and ranges of values, both whole and fractional, including and between the aforementioned values, are hereby expressly contemplated for use herein.

In some embodiments, the near-Newtonian viscosity profile of the composition is described according to a viscosity ratio between viscosities taken at two different shear rates, where a ratio of 1 models a Newtonian profile. In some embodiments, for example, the near-Newtonian viscosity profile of the composition is demonstrated by the composition exhibiting a ratio of viscosity at a shear rate of 0.1 s⁻¹ to viscosity at a shear rate of 10 s⁻¹ (i.e., a “viscosity ratio (0.1s⁻¹/10 s⁻¹))” of less than 10, alternatively of less than 8, alternatively of less than 6, alternatively of less than 4, alternatively of less than 3, alternatively of less than 2, alternatively of less than 1.5. In various non-limiting embodiments, all values and ranges of values, both whole and fractional, including and between the aforementioned values, are hereby expressly contemplated for use herein.

In various embodiments, the composition includes a viscosity recovery of at least 60%, alternatively at least 65%, alternatively at least 70%, alternatively at least 75%, alternatively at least 80%, alternatively at least 85%, alternatively at least 90%, alternatively at least 95% within about 1 to about 30 s following exposure to a shear rate 12,000 s⁻¹. In these or other embodiments, the composition includes a viscosity recovery of at least 60%, alternatively at least 65%, alternatively at least 70%, alternatively at least 75%, alternatively at least 80%, alternatively at least 85%, alternatively at least 90%, alternatively at least 95% within 15s following exposure to a shear rate 12,000 s⁻¹. In these or yet other embodiments, the composition includes a viscosity recovery of at least 60%, alternatively at least 65%, alternatively at least 70%, alternatively at least 75%, alternatively at least 80%, alternatively at least 85%, alternatively at least 90%, alternatively at least 95% within 2 s following exposure to a shear rate 12,000 s⁻¹. In various non-limiting embodiments, all values and ranges of values, both whole and fractional, including and between the aforementioned values, are hereby expressly contemplated for use herein.

### Method of Forming the Article:

As first described above, the composition can be used in various applications, such as sag-free application, overspray free application, drop-on-demand application, and/or application using a high efficiency applicator. This disclosure further provides a method of forming an article. The method includes the steps of:
a. providing a structure that has a surface;
b. disposing a coating substrate on the surface of the structure;
c. partially drying the coating substrate such that the coating substrate has a solids content of greater than about 80 wt %, based on a total weight of the coating substrate;
d. providing the aqueous coating composition; and
e. subsequently applying droplets of the aqueous coating composition onto the coating substrate; wherein the composition is visibly free of sag, determined by a 90-degree tilt test.

### Providing the Structure:

The method includes the step of providing a structure that has a surface. The structure may be provided by any method known in the art, e.g. from any source. The structure may be any type of structure known in the art. In various embodiments, the structure includes a metal, a plastic, or combinations thereof.

In various embodiments, the structure is a vehicle, automobile, or automobile vehicle. A “vehicle” or “automobile” or “automobile vehicle” includes an automobile, such as, car, van, mini van, bus, SUV (sports utility vehicle); truck; semi truck; tractor; motorcycle; trailer; ATV (all terrain vehicle); pickup truck; heavy duty mover, such as, bulldozer, mobile crane and earth mover; airplanes; boats; ships; and other modes of transport. The composition may also be utilized to coat structures in industrial applications such as buildings; fences; ceramic tiles; stationary structures; bridges; pipes; cellulosic materials (e.g., woods, paper, fiber, etc.). The composition may also be utilized to coat structures in consumer products applications such as helmets; baseball bats; bicycles; and toys.

Various structures may include two or more discrete portions of different materials. For example, vehicles can include metal-containing body portions and plastic-containing trim portions. Due to the bake temperature limitations of plastics (80° C.) relative to metals (140° C.), the metal-containing body portions and the plastic-containing trim portions may be conventionally coated in separate facilities thereby increasing the likelihood for mismatched coated parts.

The structure has or defines a surface that may or may not include a layer or a film of a primer and/or a surfacer disposed thereon. The layer of the primer and/or the surfacer may be wet or dry. Conditioning and/or drying times and temperatures of the primer and/or surfacer can be determined by a skilled person. The specific conditions can vary based on various factors such as physical drying and reactivity of the primer and/or surfacer, the amount and type of solvent, catalyst, additives, etc. present, and external factors.

### Disposing the Coating Substrate on the Surface:

The step of disposing the coating substrate on the surface of the structure may be further described as applying the coating substrate onto the surface of the structure. The coating substrate may be applied onto the surface using various techniques known in the art.

For example, in various embodiments, the coating substrate can be applied to the structure via a conventional coating method, e.g. spraying. In other embodiments, the coating substrate is applied via a high transfer efficiency applicator. Accordingly, the step of applying the coating substrate on the surface of the surface may or may not be a drop-on-demand (DOD) method.

Prior to the step of partially drying, the coating substrate may be further described as a diluted coating, e.g. has a solids content of equal to or less than about 80 wt %. In various embodiments, prior to the step of partially drying, the coating substrate has a solids content of equal to or less than about 80 wt %, less than about 75 wt %, less than about 70 wt %, less than about 65 wt %, less than about 60 wt %, less than about 55 wt %, or less than about 50 wt %, based on a total weight of the coating substrate. In various non-limiting embodiments, all values and ranges of values, both whole and fractional, including and between the aforementioned values, are hereby expressly contemplated for use herein.

The coating substrate may vary depending on applications. In various embodiments, the coating substrate is waterborne and includes water, e.g. as a carrier, a solvent, a diluent, etc. The particular components of the composition and the application method may affect the amount of water in the composition. Accordingly, the amount of water present in the waterborne coating substrate can vary, e.g. depending on particular components of the coating substrate and the application method. In various embodiments, the waterborne coating substrate can include from about 30 to about 90 wt. % of water, based on the total weight of the coating substrate. In other embodiments, the composition includes from about 35 to about 85 wt %, about 40 to about 80 wt %, about 45 to about 75 wt %, about 50 to about 70 wt %, or about 55 to about 65 wt %, based on a total weight of the coating substrate. In various embodiments, all values and ranges of values, both whole and fractional, including and between the aforementioned values, are hereby expressly contemplated for use herein.

In other embodiments, the coating substrate is solvent-borne and includes an organic solvent, e.g. as a carrier, a diluent, etc. The organic solvent typically used in the coating substrate may be any organic solvent known in the art. As first described above, non-limiting examples of organic solvents include alcohols, hydrocarbons, ketones, esters, glycols, etc., and combinations thereof, as further detailed above. The organic solvent may be present in the solvent-borne coating substrate in an amount of from about 30 to about 90 wt %, based on the total weight of the coating substrate. In other embodiments, the composition includes from about 35 to about 85 wt %, about 40 to about 80 wt %, about 45 to about 75 wt %, about 50 to about 70 wt %, or about 55 to about 65 wt %, of an organic solvent, based on a total weight of the coating substrate. In various embodiments, all values and ranges of values, both whole and fractional, including and between the aforementioned values, are hereby expressly contemplated for use herein.

Furthermore, the coating substrate may be any type of coating known in the art and may be alternatively described as a “coating”. For example, the coating may be a primer, a surfacer, a basecoat, etc. The coating substrate may have various physical properties, e.g. includes a pigment or clear, solvent-borne or waterborne, various rheology properties, etc., which may be formulated or selected by the skilled person, depending on different applications.

The coating substrate may be applied directly on and in contact with the surface of the structure. Alternatively, there may be one or more additional layers of coatings, e.g. primer, surfacer, basecoat, etc. that are different from the coating substrate that are present on the surface of the structure. In such a scenario, the coating substrate may be applied on, but spaced apart from, the surface of the structure and may be disposed on and in direct contact with the surface of one or more of the other layers described above.

### Partially Drying the Coating Substrate:

The method further includes the step of partially drying the coating substrate. The coating substrate is partially dried such that the coating substrate has a solids content of greater than about 80 wt %, based on a total weight of the coating substrate, e.g., after the step of partially drying. The step of partially drying may be performed at a temperature and/or time period to sufficiently evaporate liquid content, e.g. water and/or organic solvent, as determined by a skilled person. In various embodiments, the solids content of the coating substrate after the step of partially drying is from about 80 to about 100 wt %, about 85 to about 95 wt %, or about 85 to about 90 wt %. In other embodiments, the solids content of the coating substrate after the step of partially drying is greater than about 90 wt %. In various non-limiting embodiments, all values and ranges of values, both whole and fractional, including and between the aforementioned values, are hereby expressly contemplated for use herein.

The step of partially drying may be further described as flash drying, or dehydrating. In various embodiments, the step of partially drying can be performed at a temperature of from about 50 to about 150° C., alternatively from about 60 to about 140° C., about 70 to about 130° C., about 80 to about 120° C., about 90 to about 110° C., or about 90 to about 100° C. In various non-limiting embodiments, all values and ranges of values, both whole and fractional, including and between the aforementioned values, are hereby expressly contemplated for use herein.

In other embodiments, the step of partially drying, performed at any one of the temperatures described above, may be performed for a time period of from about 1 to about 30 minutes, e.g. about 1 minute, about 2 minutes, about 3 minutes, about 4 minutes, about 5 minutes, about 10 minutes, about 15 minutes, about 20 minutes, about 25 minutes, or about 30 minutes. In various non-limiting embodiments, all values and ranges of values, both whole and fractional, including and between the aforementioned values, are hereby expressly contemplated for use herein.

In various embodiments, the method includes the step of partially drying the coating substrate at a temperature of about 50 to about 150, about 55 to about 145, about 60 to about 140, about 65 to about 135, about 70 to about 130, about 75 to about 125, about 80 to about 120, about 85 to about 115, about 90 to about 110, about 95 to about 105, about 90 to about 100, or about 90 to about 95° C. and in a time period of from about 1 to about 30, about 5 to about 25, about 10 to about 20, or about 15 to about 20, minutes. In various non-limiting embodiments, all values and ranges of values, both whole and fractional, including and between the aforementioned values, are hereby expressly contemplated for use herein.

In various other embodiments, the step of partially drying is further described as flashing or flash drying, and occurs at room temperature, in a time period of from about 3 to about 10 minutes. In yet other embodiments, the step of partially drying occurs at about 60 to about 85° C., in a time period of from about 3 to about 15 minutes.

The step of partially drying can be described as different from curing. It is contemplated that the partially dried but uncured coating substrate can allow the composition to soak into the coating substrate, minimizing sag without the need for a thickener.

### Providing the Composition:

The method also includes the step of providing the composition. The step of providing is not particularly limited and may be any known in the art. For example, the step of providing may be described as providing one or more components of the composition, in whole or in part, combining these components to form the composition, and then providing the completed composition. Alternatively, the step of providing may be described as pumping, flowing, moving, or otherwise delivering one or more components of the composition or the composition as a whole, e.g. to a high transfer efficiency applicator, a drop-on-demand applicator, etc. The step of providing may be described as a continuous process or a batch process. Similarly, the step of providing may include continuous sub-steps and/or batch sub-steps. In various embodiments, the step of providing is described as pumping the composition to the applicator under pressure. The step of providing may be as understood by one of skill in the art.

### Applying the Composition:

The method also includes the step of applying droplets of the composition onto the coating substrate. In various embodiments, the coating substrate is not cured and the step of applying is a wet-on-wet application. Alternatively, the coating substrate composition may be partially or entirely cured. In other embodiments, the step of applying is a wet-on-dry application.

The step of applying is not particularly limited. In various embodiments, the step of applying is further defined as jetting, e.g. jetting through the high transfer efficiency applicator. For example, in various embodiments, the applicator is as described in one or more of patent numbers US20150375258A1, US20040217202 A1, US 2009/0304936 A1, U.S. Pat. No. 7,824,015 B2, U.S. Pat. No. 8,091,987 B2, WO 2018/206309 A1, and WO 2019/108938 A1; each of which are expressly incorporated herein in their entirety in various non-limiting embodiments. Similarly, a method of using the applicator and/or any one or methods or steps described herein may alternatively be as described in one or more of the aforementioned references.

Alternatively, the step of applying may be further defined as printing. In certain embodiments, the step of applying may be defined as digital printing. In other embodiments, the step of applying may be defined as drop-on-demand (DOD) printing. The DOD printing may be performed using any equipment known in the art, which may employ various mechanisms to print, e.g. thermal DOD, piezoelectric DOD, etc.

In various embodiments, the step of applying uses a DOD applicator, to generate and eject droplets of the composition only when needed, rather than continuously and can improve placement precision and minimizes waste. The applicator can create a pressure pulse within a fluid chamber of a printhead, which forces droplets of the composition through a nozzle, e.g. of the high transfer efficiency applicator.

The nozzle can typically have a diameter of from about 10 to about 500 microns. In various embodiments, the diameter of the nozzle is from about 50 to about 450 microns, about 100 to about 400, about 150 to about 350, or about 200 to about 300 microns, depending on the type of the applicator and the applications. In various non-limiting embodiments, all values and ranges of values, both whole and fractional, including and between the aforementioned values, are hereby expressly contemplated for use herein.

Depending on the type of the applicator and the diameter of the nozzle, the droplets of composition expelled may vary in size. For example, the droplets may have a Dv10, Dv50, Dv90, Dn10, Dn50, and/or Dn90 particle size each independently as described below, e.g. each independently of from about 10 to about 100, about 20 to about 90, about 30 to about 80, about 40 to about 70, about 50 to about 60, microns. The size of the droplets may be determined using any apparatus known in the art. In various embodiments, the droplet size is determined using high-speed stroboscopic imaging device to capture images of the droplets mid-flight for analysis. The high-speed stroboscopic imaging device may be configured as determined appropriate by one skilled in the art. In various embodiments, the device is a JetXpert® dropwatcher system, a product of ImageXpert LLC, which uses a high-speed camera and strobe light synchronized with the printhead to capture images of individual ink droplets in flight, allowing detailed analysis of drop size. In various non-limiting embodiments, all values and ranges of values, both whole and fractional, both between and including each of the above, are hereby expressly contemplated for use herein.

In various embodiments, at least about 99.5, 99.6, 99.7, 99.8, 99.9, or even higher, % of the droplets of the composition expelled from the high transfer efficiency applicator or the DOD applicator are monodispersed such that the droplets have a particle size distribution of less than about 20%, alternatively less than about 15%, alternatively less than about 10%, alternatively less than about 5%, alternatively less than 3%, alternatively less than 2%, alternatively less than 1%, or alternatively less than about 0.1%. While conventional applicators rely on atomization to form “a mist” of atomized droplets of a composition having a dispersed particle size distribution, the monodispersed droplets by the high transfer efficiency applicator can be directed to the structure thereby resulting in an improved transfer efficiency relative to conventional applicators. In various non-limiting embodiments, all values and ranges of values, both whole and fractional, including and between the aforementioned values, are hereby expressly contemplated for use herein.

The step of applying the composition may be performed to achieve various film builds, which can be used to describe the thickness of a layer of the composition, e.g. before drying, i.e. wet film build, or after drying, i.e. dry film build. Large film build, e.g. greater than about 10 microns dried film or greater than about 50 microns wet film, can increase sag. In contrast, low film build, e.g. less than about 2 microns dried film or less than about 8 microns wet film, can affect coating efficiency and coverage. Accordingly, the dry film build may be from about 2 to about 10 microns, e.g. about 3 to about 9 microns, about 4 to about 8 microns, about 5 to about 7 microns, or about 5 to about 6 microns. Suitable wet film build for sag-free performance generally is associated with the solids content of the composition, method of drying, etc. The wet film build may be from about 8 to about 50 microns, e.g. about 10 to about 40 microns, about 15 to about 35 microns, about 20 to about 30 microns, or about 20 to about 25 microns. In various non-limiting embodiments, all values and ranges of values, both whole and fractional, including and between the aforementioned values, are hereby expressly contemplated for use herein.

The film builds described above may be used for various compositions. Specifically, the film build may be used for application of compositions that include a black pigment. The film build can vary depending on the type of pigment used. For example, a larger film build may be used to improve coating coverage of compositions that include a lighter pigment, e.g. a white pigment.

The film build may be accessed using various methods which may be selected by the skilled person. For example, the film build may be accessed using a high ink sticker, which may be applied onto a portion of the surface of the structure, or of the coating substrate. Generally, suitable film builds can provide coverage that such the high ink sticker is not visible by the naked eye.

The step of applying may be further described as overspray-free. The terminology “overspray-free” can be used to describe the amount, ratio, and/or percentage of the composition that contacts the coating substrate on the structure. In various embodiments, at least about 99.5, 99.6, 99.7, 99.8, 99.9, or even higher, % of the number of droplets of the composition expelled from the high transfer efficiency applicator or the DOD applicator contact the coating substrate. Without being bound by theory, it is believed that an increase in the number of droplets contacting the coating substrate relative to the number of droplets that do not contact the coating substrate thereby entering the environment, improves efficiency of application of the composition, reduces waste generation, and reduces maintenance. Alternatively, at least about 99.5, 99.6, 99.7, 99.8, 99.9, or even higher, % of the volume of droplets of the composition expelled from the high transfer efficiency applicator or the DOD applicator contact the coating substrate. Even further, it is contemplated that at least about 99.5, 99.6, 99.7, 99.8, 99.9, or even higher, % of the total weight of droplets of the composition expelled from the high transfer efficiency applicator or the DOD applicator contact the coating substrate. In various non-limiting embodiments, all values and ranges of values, both whole and fractional, including and between the aforementioned values, are hereby expressly contemplated for use herein.

As a result, in various embodiments, there is nearly 100% transfer efficiency (approximately all droplets of the coating composition are deposited to a targeted location on the coating substrate.) As will be appreciated by one of skill in the art, some allowance is made for start-up and stopping the high transfer efficiency applicator. Devices of this type can be described as drop-on-demand, overspray-free, or ultra-high transfer efficiency applicators.

These devices are different from spray atomization devices and techniques wherein energy, such as pneumatic, hydraulic, or centrifugal, energy, is introduced to create a partially controlled, random distribution of droplet sizes, trajectories and speeds, and wherein some additional mechanism, e.g. electrostatics and or shaping air, then guides a paint droplet cloud to a structure. Relative to traditional paint spray, there is always some overspray and transfer efficiency loss.

During the step of applying, a loss of volatiles after application through the high transfer efficiency applicator or the DOD applicator can be less than about 0.5 weight percent actives based on a total weight of the composition. In various embodiments, this amount is less than about 0.4, 0.3, 0.2, or 0.1, weight percent actives based on a total weight of the composition. Typically, the terminology “volatiles” is defined as substances which will evaporate thereby resulting in a weight loss of the composition. Loss of volatiles after application can be determined by the increase in wt % solids after over before application where % solids in each case would be determined gravimetrically by ASTM D2369-10, as published in 2024. In various non-limiting embodiments, all values and ranges of values, both whole and fractional, including and between the aforementioned values, are hereby expressly contemplated for use herein.

### Free of Sag:

The composition is visibly free of sag, e.g. when applied to the coating substrate having a solids content of greater than about 80 wt %. It is contemplated that the coating substrate composition may be dried, either before or after application of the aqueous composition thereto, such that it has the aforementioned solids content.

Methods of determining sag are not limited and may be any known in the art. For example, sag can be determined using a sag meter test, a tilt test, e.g. at an incline of from about 10 to about 90 degrees, such as 10-degree, 45-degree, 90-degree, etc., a leneta sag test, etc. or using a standardized test such as ASTM D4400, as published in 2024.

The presence of sag, or lack thereof, can be assessed visibly, for example, by evaluating the uniformity of the thickness of the composition, e.g. applied to the coating substrate, by observing flow lines and streaks, by inspecting the edge of the structure used in sag testing.

In various embodiments, the composition is free of sag, determined by a 90-degree tilt test. Typically, a structure is oriented horizontally prior to the step of applying. The composition is applied onto the coating substrate on the structure, as first described above. After application of the composition, the structure is tilted at an angle of about 90 degrees from horizontal. After about a time period, typically from about 1 to 10 minutes at room temperature, the coating substrate is dried as also described above, followed by a clearcoat spray and finally baked to full cure. Sag, if present, can be visible as drips at the bottom edge of the structure.

Presence of drips can increase the thickness of the composition at the bottom edge, by at least 50%. In various embodiments, the composition, applied to the coating substrate on the structure, provides sag-free performance which can be defined as when the thickness of the bottom edge does not increase, or increases less than about 50%, alternatively less than 40%, less than 30%, less than 20%, less than 10%, or less than 9, 8, 7, 6, 5, 4, 3, 2, or 1, % in height, length, or thickness, in a 90-degree tilt test. In various non-limiting embodiments, all values and ranges of values, both whole and fractional, including and between the aforementioned values, are hereby expressly contemplated for use herein.

The method may or may not include a step of curing, either in part or in whole, one or more of the aforementioned layers and/or compositions. The step of curing is not particularly limited and may be any known in the art.

The method may additionally include the step of curing the coating substrate, the composition, and/or any additional coating layer. The step of curing is not particularly limited and may depend on the coating layer(s) and their components. In various embodiments, the step of curing occurs at a temperature of from about 70 to about 180° C. In other embodiments, the step of curing occurs at a temperature of from about 80 to about 170° C., about 90 to about 160° C., about 100 to about 150° C., about 110 to about 140° C., or about 120 to about 130° C. In various non-limiting embodiments, all values and ranges of values, both whole and fractional, including and between the aforementioned values, are hereby expressly contemplated for use herein.

Depending on the coating layer(s) and/or the curing temperature used, the step of curing may be performed in a time period of from about 15 to about 60 minutes. In various embodiments, the step of curing is performed in a time period of from about 15 to about 60 minutes, about 20 to about 55 minutes, about 25 to about 50 minutes, about 30 to about 45 minutes, or about 35 to about 40 minutes. In various non-limiting embodiments, all values and ranges of values, both whole and fractional, including and between the aforementioned values, are hereby expressly contemplated for use herein. In various embodiments, the coating layer(s) is cured at about 140° C. for 30 minutes.

### Article:

This disclosure also provides the article itself. The article includes the structure that has the surface, the coating substrate disposed on the surface of the structure, the aqueous coating composition disposed on and in contact with the coating substrate. In various embodiments, the article is not yet cured. However, this disclosure also provides a cured article which includes the structure, the cured product of the coating substrate, and the cured product of the aqueous coating composition.

### EXAMPLES

Various compositions were prepared using the materials and parameters set forth in Table 1 below. After formulation, the compositions were evaluated as set forth further below.

Compositions 1 to 11 were evaluated via controlled shear rate flow sweep and time sweep experiments to assess demonstrable shear thinning behavior, according to ASTM D2196, as published in 2024. The results of the evaluation are also set forth in Table 1.

TABLE 1
Formulations of Aqueous Coating Compositions

| Example | 1 | 2 | 3 | 4 | 5 | 6 | 7 | 8 | 9 | 10 | 11 |
|---|---|---|---|---|---|---|---|---|---|---|---|
| Melamine 1 | 1.03 | 1.03 | 1.03 | 1.03 | 1.03 | 1.03 | 1.03 | 1.03 | 1.03 | 1.03 | 1.03 |
| Melamine 2 | 3.35 | 3.35 | 3.35 | 3.35 | 3.35 | 3.35 | 3.35 | 3.35 | 3.35 | 3.35 | 3.35 |
| Polyol 1 | 1.44 | 1.44 | 1.44 | 1.44 | 1.44 | 1.44 | 1.44 | 1.44 | 1.44 | 1.44 | 1.44 |
| Polyol 2 | 2.00 | 2.00 | 2.00 | 2.00 | 2.00 | 2.00 | 2.00 | 2.00 | 2.00 | 2.00 | 2.00 |
| Polyurethane | 7.69 | 7.69 | 7.69 | 7.69 | 7.69 | 7.69 | 7.69 | 7.69 | 7.69 | 7.69 | 7.69 |
| dispersion 1 | | | | | | | | | | | |
| Polyurethane | 14.9 | 14.9 | 14.9 | 14.9 | 14.9 | 14.9 | 14.9 | 14.9 | 14.9 | 14.9 | 14.9 |
| dispersion 2 | | | | | | | | | | | |
| Polyurethane | 1.09 | 1.09 | 1.09 | 1.09 | 1.09 | 1.09 | 1.09 | 1.09 | 1.09 | 1.09 | 1.09 |
| dispersion 3 | | | | | | | | | | | |
| Acrylic latex | 7.11 | 7.11 | 7.11 | 7.11 | 7.11 | 7.11 | 7.11 | 7.11 | 7.11 | 7.11 | 7.11 |
| dispersion | | | | | | | | | | | |
| Leveling | 2.57 | 2.57 | 2.57 | 2.57 | 2.57 | 2.57 | 2.57 | 2.57 | 2.57 | 2.57 | 2.57 |
| agent | | | | | | | | | | | |
| Black | 10.2 | 10.2 | 10.2 | 10.2 | 10.2 | 10.2 | 10.2 | 10.2 | 10.2 | 10.2 | 10.2 |
| pigment | | | | | | | | | | | |
| dispersion | | | | | | | | | | | |
| Wetting | 1.00 | 1.00 | 1.00 | 1.00 | 1.00 | 1.00 | 1.00 | 1.00 | 1.00 | 1.00 | 1.00 |
| agent | | | | | | | | | | | |
| Cosolvent | 5.00 | 5.00 | 5.00 | 5.00 | 5.00 | 5.00 | 5.00 | 5.00 | 5.00 | 5.00 | 5.00 |
| Deionized | 41.7 | 40.6 | 40.4 | 40.1 | 40.7 | 39.0 | 38.6 | 40.9 | 40.5 | 40.1 | 39.4 |
| water | | | | | | | | | | | |
| Amine | 0.95 | 0.97 | 0.98 | 1.00 | 1.49 | 2.47 | 2.69 | 1.38 | 1.60 | 1.82 | 2.25 |
| HEUR | 0 | 1.00 | 1.25 | 1.50 | 0 | 0 | 0 | 0 | 0 | 0 | 0 |
| thickener | | | | | | | | | | | |
| Alkali | 0 | 0 | 0 | 0 | 0.41 | 1.16 | 1.32 | 0.33 | 0.50 | 0.66 | 0.99 |
| swellable | | | | | | | | | | | |
| thickener | | | | | | | | | | | |
| Viscosity at | 13 | 46 | 49 | 77 | — | — | 65 | 21 | 25 | 29 | 44 |
| 1000 s − 1 | | | | | | | | | | | |

Melamine 1 is a methylated high imino melamine crosslinker in isobutyl. Melamine 2 is a hexamethoxymethyl-melamine-formaldehyde resin.

Polyol 1 is a 425-molecular-weight polypropylene glycol.

Polyol 2 is Tripropyleneglycol.

Polyurethane dispersion 1 is formed from a linear polyester diol resin (reaction product of monomers 1,6-hexanediol, adipic acid, and isophthalic acid) and isophorone diisocyanate, having a solids content of about 35 wt %.

Polyurethane dispersion 2 is formed from a linear polycarbonate-polyester polyol (equivalent weight of about 1000, hydroxyl content 1.7%, Desmohpen C1200) and isophorone diisocyanate, having a solids content of about 38 wt %.

Polyurethane 3 is formed from a linear polycarbonate-polyester polyol (equivalent weight ~1000, hydroxyl content 1.7%, Desmohpen C1200) and isophorone diisocyanate, having a solids content of about 38 wt %.

Acrylic latex dispersion is formed by a two-step emulsion polymerization process, about 46 wt % solid, Tg of about-2C, acid number of about 12, hydroxyl number of about 7. The Leveling Agent is an acrylic-based leveling agent.

The Black Pigment Dispersion is Dispersion of amorphous carbon black pigment Cosolvent is isotridecanol.

Amine is 10 wt % dimethylethanolamine solution.

The HEUR thickener is a non-ionic associate hydrophobically modified ethylene oxide urethane thickener.

Alkali swellable thickener is an acrylic alkali emulsion.

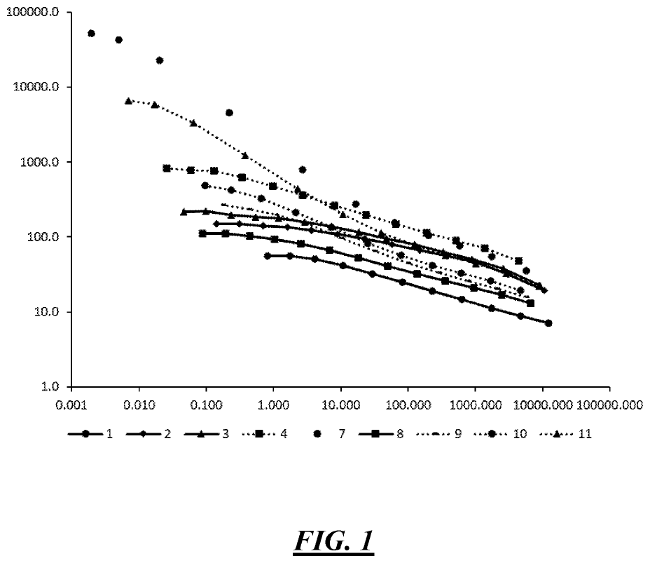

The viscosity was determined according to ASTM7867-13, as published in 2024. The results are set forth in FIG. 1 which is a plot of viscosity as a function of sheer rate, resulting from a controlled shear rate flow sweep, measured according to the aforementioned ASTM7867-13, as published in 2024.

Compositions 1 to 7 were further evaluated to evaluate sag, using the following procedure: A panel is oriented horizontally prior to coating application. A waterborne basecoat is applied on the panel using a bell spray with e-stat to achieve a dried film build of about 18 microns, followed by a 5-minute ambient temperature flash, and a dehydration step at about 70° C. for about 9 minutes. Next, the composition is applied onto the dehydrated basecoat using a Xaar Aquinox GS6 printhead to achieve a dry film build of about 3 to about 7 microns. After application of the composition, the panel is tilted so that the panel is disposed at an angle of about 90 degrees from horizontal. At this position, e.g. tiled 90°, the composition undergoes the same flash and dehydration conditions as described above. Sag evaluation is performed after the dehydration of the composition. A 2K clear coat is applied onto the composition using the bell spray to achieve a 60-micron dry film build. The clear coat is then flashed at ambient temperature for about 7 minutes, and cured at 93° C. for about 10 minutes, and at 140° C. for about 20 minutes. Sag evaluation after curing is also performed. Sag, if present, is evidenced by drips at the bottom edge of the coating, and is evaluated visually.

The sag tests using Composition 1 show minimal or drip free performance and/or minimal sag, at a dry film build of about 5 microns. Compositions 2 to 7 also show minimal sag, at a dry film build of about 10 microns This is evidence that the compositions, even without the use of thickener, exhibits good performance and can be used for sag-free applications, providing similarly good performance and appearance compared to the comparative compositions which include one or more thickeners.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. An aqueous coating composition comprising:
water;
a crosslinker;
a resin dispersion comprising a latex, a polyurethane, or combinations thereof;
wherein the composition is free of a thickener;
wherein the composition exhibits a viscosity of less than or equal to about 100 cP, measured at a shear rate of from about 0.1 s⁻¹ to about 10 s⁻¹; and
wherein the composition is visibly free of sag, determined by a 90-degree tilt test, after being applied to and in direct contact with a partially dried coating substrate having a solids content of greater than about 80 wt %, based on a total weight of the coating substrate.

2. The composition of claim 1 wherein the crosslinker is chosen from a melamine crosslinker, an isocyanate crosslinker, and combinations thereof.

3. The composition of claim 1 wherein the crosslinker is present in an amount of from about 1 to about 30 wt %, based on a total weight of the composition.

4. The composition of claim 1 wherein the dispersion is present in an amount of from about 1 to about 50 wt %, based on a total weight of the composition.

5. The composition of claim 1 further comprising a polyester-polyurethane polymer.

6. The composition of claim 1 further comprising an additive chosen from a pigment, a cosolvent, a catalyst, a UV absorber, a leveling agent, a wetting agent, and combinations thereof.

7. The composition of claim 1 wherein the composition exhibits a viscosity of less than or equal to about 50 cP, measured at a shear rate of from about 0.1 s⁻¹ to about 10 s⁻¹.

8. A method of forming an article; said method comprising the steps of:
a. providing a structure that has a surface;
b. disposing a coating substrate on the surface of the structure;
c. partially drying the coating substrate such that the coating substrate has a solids content of greater than about 80 wt %, based on a total weight of the coating substrate;
d. providing an aqueous coating composition comprising:
water;
a crosslinker;
a resin dispersion comprising a latex, a polyurethane, or combinations thereof;
wherein the composition is free of a thickener; and
wherein the composition exhibits a viscosity of less than or equal to about 100 cP, measured at a shear rate of from about 0.1 s⁻¹ to about 10 s⁻¹; and
e. subsequently applying droplets of the composition onto the coating substrate; wherein the composition is visibly free of sag, determined by a 90-degree tilt test.

9. The method of claim 8 wherein the coating substrate is waterborne.

10. The method of claim 8 wherein the coating substrate is solvent-borne.

11. The method of claim 8 wherein the coating substrate has a solids content of greater than about 90 wt %, based on a total weight of the coating substrate, after the step of partially drying.

12. The method of claim 8 wherein the coating substrate is not cured and the step of applying is further defined as wet-on-wet.

13. The method of claim 8 wherein the step of applying uses a drop-on-demand applicator.

14. The method of claim 8 wherein the composition is visibly free of sag, determined by a 90-degree tilt test.

15. The method of claim 8 wherein greater than about 99.5% of the total number of droplets applied contact the coating substrate.

16. The method of claim 8 wherein the droplets have a size distribution that is approximately monodispersed.

17. The method of claim 8 wherein the droplets have a diameter Dv50 of from about 10 to about 100 microns as determined using a stroboscopic imaging device.

18. The method of claim 8 further comprising the step of partially drying the coating substrate at a temperature of about 50 to about 150° C. and in a time period of from about 1 to about 30 minutes.

19. The method of claim 8 wherein the structure comprises a metal, a plastic, or combinations thereof.

20. An article comprising:
a structure that has a surface;
a partially dried coating substrate disposed on the surface of the structure;
wherein the coating substrate has a solids content of greater than about 80 wt %, based on a total weight of the coating substrate; and
an aqueous coating composition disposed on and in contact with the coating substrate wherein the composition comprises:
water;
a crosslinker;
a resin dispersion comprising a latex, a polyurethane, or combinations thereof;
wherein the composition is free of a thickener; and
wherein the composition exhibits a viscosity of less than or equal to about 100 cP, measured at a shear rate of from about 0.1 s⁻¹ to about 10 s⁻¹; and
wherein the composition is visibly free of sag, determined by a 90-degree tilt test.
